(19) United States
(12) Patent Application Publication
(10) Pub. No.: US 2007/0171664 A1
(43) Pub. Date: Jul. 26, 2007

(54) Rotary wheel with a rowed-lights displaying device

(75) Inventors: Ching-Tu Shih, Changhua County (TW); Chin-Tang Huang, Tainan County (TW)

Correspondence Address: BACON & THOMAS, PLLC, 625 SLATERS LANE, FOURTH FLOOR, ALEXANDRIA, VA, 22314, US

(73) Assignee: Tonic Fitness Technology, Inc., Tainan Hsien (TW)

(21) Appl. No.: 11/338,766

(22) Filed: Jan. 25, 2006

(51) Int. Cl. B60Q 1/00; B60Q 1/26; F21V 23/04

(52) U.S. Cl. 362/500; 362/800; 362/276; 362/464; 362/802; 362/811

(57) ABSTRACT

A rotary wheel with a rowed-lights displaying device includes a rotary wheel, a set of rowed-lights, a detecting member and a controller. The set of rowed-lights set on the rotary wheel is provided with a row of lights controlled by the controller to turn on once while rotating for a preset angle along with the rotary wheel. The detecting member can detect the rotation speed of the rotary wheel and transmit the value of the speed to the controller that is able to calculate the time needed for the rotary wheel to rotate a preset angle to enable each light of the rowed-lights to precisely turn on/off as set up previously. Via the photogene theory, a person's eyes can see a complete message designed in advance by means of the lit rowed-rights on the rotary wheel.

### BACKGROUND OF THE INVENTION

1. Field of the Invention

This invention relates to a rotary wheel with a rowed-lights displaying device, particularly to one provided with a detecting member for detecting the rotation speed of the rotary wheel and a controller receiving the value of the rotation speed to calculate the time needed for the rotary wheel to rotated for a preset angle so as to make the rowed-lights turned on. And, via the photogene theory, a person can see the data expressed by the lit rowed lights on the rotary wheel.

2. Description of the Prior Art

A flying wheel of an exercise bike or a bicycle's wheel etc. is herein defined as a rotary wheel. Usually, a flying wheel of an exercise bike is simply used as a dragging wheel without any other effect while treading it. A bicycle's wheel is only to help a bicycle to roll forwards.

### SUMMARY OF THE INVENTION

The prime object of this invention is to offer a rotary wheel with a rowed-lights displaying device.

The main characteristics of the invention are a rotary wheel, a set of rowed-lights, a detecting member and a controller. The rowed-lights set on the rotary wheel is provided with a row of lights controlled by the controller to turn on once while rotating for a preset angle along with the rotary wheel. The detecting member can detect the rotation speed of the rotary wheel and transmit the value of the speed to the controller that is able to calculate the time needed for the rotary wheel to rotate for a preset angle to enable each light of the rowed-lights to precisely turn on/off as set up previously. Via the photogene theory, a person can see a complete message expressed by the lit rowed lights on the rotary wheel.

### BRIEF DESCRIPTION OF DRAWINGS

This invention is better understood by referring to the accompanying drawings, wherein:

FIG. 1 is a front view of a preferred embodiment of a rotary wheel with a rowed-lights displaying device in the present invention;

FIG. 2 is a block view of a controlling system in the present invention;

FIG. 3 is a front view of the preferred embodiment of a rotary wheel with a rowed-lights displaying device in the present invention, showing it being used with a stationary message;

FIG. 4 is an evolved view of FIG. 3; and

FIG. 5 is a front view of the preferred embodiment of a rotary wheel with a rowed-lights displaying device in the present invention, showing it being used with a changeable message.

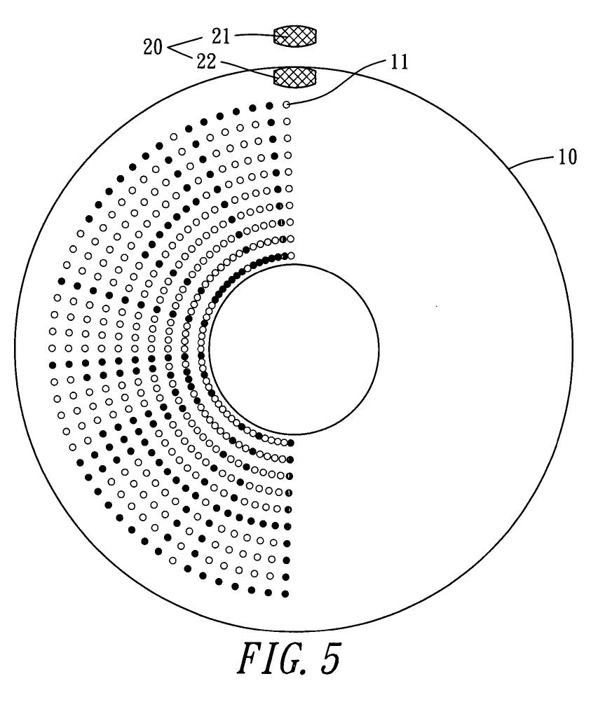

### DETAILED DESCRIPTION OF THE PREFERRED EMBODIMENT

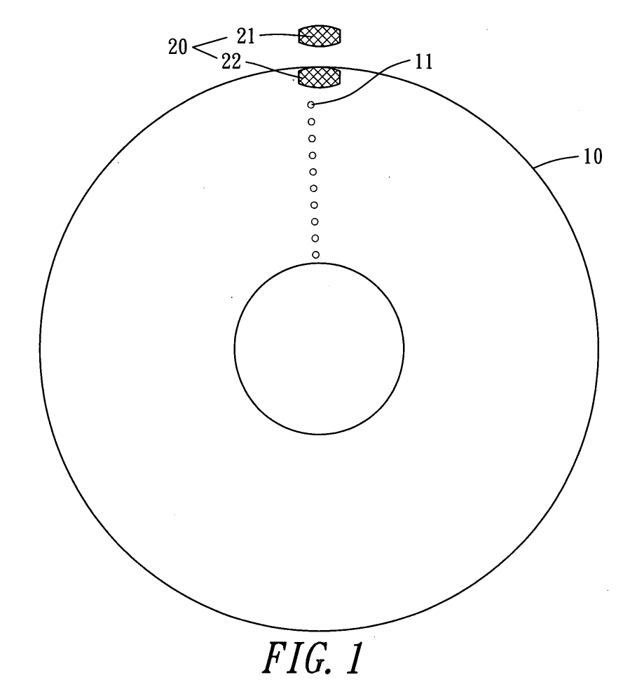

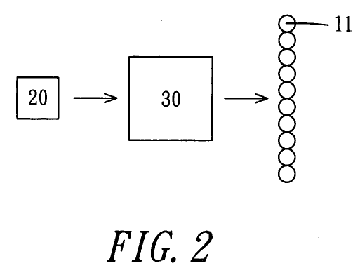

As shown in FIGS. 1 and 2, a preferred embodiment of a rotary wheel with a rowed-lights displaying device in the present invention includes a rotary wheel 10, a set of rowed-lights 11, a detecting component 20 and a controller 30 as main components.

The set of rowed-lights 11 consisting of plural lights, preferably LCDs, is fixed on the surface of the rotary wheel 10.

The detecting component 20 used to detect the rotation speed of the rotary wheel 10 is provided with a magnet 21 fixed outside the rotary wheel 10 and a reed switch 22 fixed on the surface of the rotary wheel 10 and facing the magnet 21 functioning to control the switch 22.

The controller 30, preferably a micro controller as shown in FIG. 2, is to receive a rotation speed value of the rotary wheel 10 detected by the detecting member 20 so as to precisely calculate a time taken by the rowed-lights 11 to shift or rotate for a preset angle, enabling the rowed-lights 11 to respond (turn on) once to each shift of itself. Therefore, any word or graph desired to display by the rowed lights 11 on the rotary wheel 10 can be designed previously and set for controlling turning on/off of each light of the rowed-lights 11 for each shift.

In using, examples are described below.

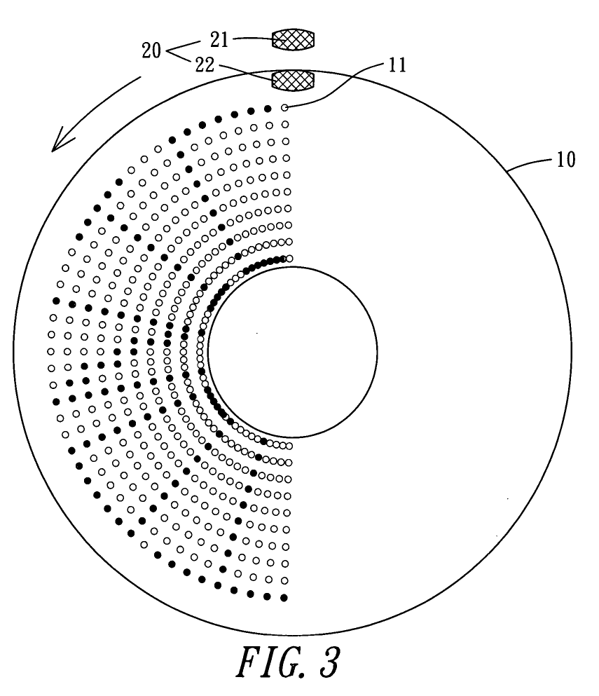

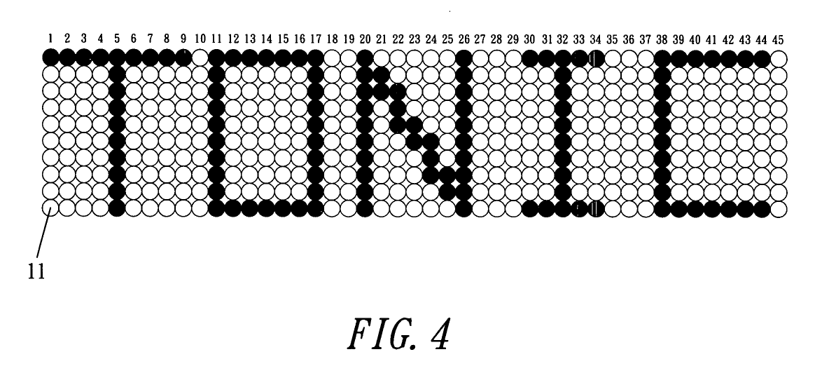

1. As shown in FIGS. 3 and 4, suppose the message hoped to display on the rotary wheel 10 is a word—TONIC—and to be spread in the angle of 180 degrees—that is half sphere of a wheel—with a shift of 4 degrees as a preset angle for each response. So, the rowed-lights 11 are set to keep only its first light (the outermost one) lit up at the very beginning. When the rowed-lights 11 is shifted to the second position, rotated for further 4 degrees, merely its first light is lit up as well; when it is shifted to the fifth position, rotated for 16 degrees, all of its lights including the first one are lit up. And so forth, the word—TONIC—is to be displayed by the lit rowed lights completely.

2. While the rowed-lights 11 are rotated with the rotary wheel 10 in the first (upper) semi-sphere, it responds (turns on) once at every preset angle of 4 degrees. It can be set not to function (turning on), so it can keep on displaying during the second half-sphere depending on requirement. Therefore, the word—TONIC—can be displayed and seen once via the photogene theory when the rotary wheel 10 is rotated one round.

3. If the rotary wheel 10 is a flying wheel of an exercise bicycle or that of a bicycle, it is to have inconstant speed of rotation because it is driven by human feet. But, the detecting member 20 set at the rim of the rotary wheel 10 is able to detect the speed of the rotary wheel 10 any time and transmit it to the controller 30, which can calculate the time (t) needed for the rotary wheel 10 to rotate half a cycle, the time for the rowed-lights 11 to move a preset angle (4 degrees) can be calculated by (t)/45 (180 degrees/4 degrees), enabling the rowed-lights 11 to respond precisely at each preset angle of one shift. For example, suppose the time (t) is 2 seconds, the responding interval for the rowed-lights 11 is 0.044 second ( 2/45=0.044). That is, the rowed-lights 11 respond once every 0.044 second in the first semi-sphere.

4. Except displaying a stationary message as described above—TONIC—, the rotary wheel 10 can also display changeable messages. For example, it can be designed to show its RPM of each interval. That is, if the RPM is detected to be 100, a message of “RPM100” is to be seen on the rotary wheel 10. If the RPM is next detected to be 120, a message of “RPM120” is to be seen on the rotary wheel 10 next.

While the preferred embodiment of the invention has been described above, it will be recognized and understood that various modifications may be made therein and the appended claims are intended to cover all such modifications that may fall within the spirit and scope of the invention.

What is claimed is:

1. A rotary wheel with a rowed-lights displaying device comprising:
a rotary wheel;
a set of rowed-lights fixed on said rotary wheel, having a row of plural lights and controlled by a controller for turning on and off;
a speed detecting member to detect the rotation speed of said rotary wheel and transmit the value of the rotation speed to said controller for calculation;
said controller able to calculate precisely the time needed for said rotary wheel to rotate for a preset angle to let said rowed lights to turn on once at each interval of said preset angle, said controller controlling each light of said rowed lights in turning on and off; and
a person's eyes able to see a designed message expressed by said lit rowed-lights on said rotary wheel by means of the photogene theory.

2. A rotary wheel with a rowed-lights displaying device as claimed in claim 1, wherein said controller is a micro controller.

3. A rotary wheel with a rowed-lights displaying device as claimed in claim 1, wherein said speed detecting member is provided with a magnet fixed outside said rotary wheel and a reed switch fixed on the surface of said rotary wheel and facing said magnet for controlling said reed switch.

4. A rowed-lights displayed on a rotary wheel as claimed in claim 1, wherein a datum expressed by said rowed-lights on said rotary wheel is a RPM of its instant speed.
